(19) United States
(12) Patent Application Publication
(10) Pub. No.: US 2002/0048692 A1
(43) Pub. Date: Apr. 25, 2002

(54) Disk medium and disk apparatus

(76) Inventors: Tetsuo Hosokawa, Higashine-shi (JP); Kiyoshi Yamaguchi, Tendo-shi (JP)

Correspondence Address: PATRICK G. BURNS, GREER BURNS & CRAIN, LTD, 300 S. WACKER DRIVE, SUITE 2500, CHICAGO, IL, 60606, US

(21) Appl. No.: 09/524,852

(22) Filed: Mar. 14, 2000

(30) Foreign Application Priority Data
Jul. 12, 1999 (JP) 11-198060

(51) Int. Cl. G11B 5/66

(52) U.S. Cl. 428/694 TS

(57) ABSTRACT

A disk medium has enhanced close contact property between the glass-based substrate and the NiP layer, and has a high shock resistance and a large signal to noise (S/N) ratio. A contact layer including Cr, a NiP layer, a Cr-based underlayer and a magnetic layer are sequentially formed on a non-magnetic substrate. The NiP layer is formed by the sputtering process in the thickness t (nm) under the substrate temperature of T (° C.) to satisfy the condition of T+t≦370. In another aspect of the invention, the disk medium is polished to form circumferential grooves having a depth larger than the maximum value of surface roughness of the NiP layer.

The present invention relates to a disk medium for a hard disk drive or magneto-optical disk drive and a method of manufacturing the same. More particularly, this invention relates to hard disks having close contact and strong adhesion between a substrate and an adjacent layer.

### BACKGROUND OF THE INVENTION

FIG. 1 is a cross-sectional diagram of a magnetic disk of the related art. The disk has a magnetic layer 5 consisting of alloy mainly composed of cobalt. The magnetic layer 5 is formed on a non-magnetic substrate 10 such as aluminum. Moreover, a non-magnetic underlayer 3 consisting of chromium alloy is provided between the substrate 10 and the magnetic layer 5. This non-magnetic underlayer 3 is intended to set the direction of easy magnetization of magnetic layer 5 in the film surface. In order to obtain sufficient strength, a NiP layer 2 is plated on the surface of substrate 10.

With the development of modern information processing techniques, improvements are constantly being sought for the realization of high recording density on magnetic disks in magnetic disk drives for computers. To increase the recording density of the magnetic disk, line recording density and track density have been increased, and the area required for recording one bit has been reduced. To realize these results, the floating height of the magnetic head has been reduced in order to assure good recording and reproducing conditions.

Here, when the floating height of the magnetic head becomes small, the possibility of the magnet in the head colliding with the magnetic disk due to shock and vibration becomes high. In order to alleviate any influence from the collision between the magnetic head and the medium, the substrate and the NiP layer are required to have higher hardness.

Referring to FIG. 2, strength is improved by using glass as the substrate. However, the close contact property (i.e., the ability to adhere) of the NiP layer 2 to the glass substrate 1 is unacceptable, so a Cr film is provided between the glass substrate 1 and the NiP layer 2 to improve the close contact property.

For example, Japanese Published Unexamined Patent Application No. HEI 5-197941 discloses a magnetic disk in which the NiP film is stacked on the glass substrate via a Cr film of 30 to 100 nm. According to this reference, coercive force is improved with an increase in strength. However, the magnetic disk disclosed has a problem in that sufficient electro-magnetic conversion characteristics cannot be obtained for high density recording.

On the other hand, Japanese Published Unexamined Patent Application No. 10-145935 discloses a magnetic disk in which the NiP layer with a thickness of 10 to 200 nm is formed on the glass substrate via the Cr film about 5 to 25 nm thick. However, although this magnetic disk provides better electro-magnetic conversion characteristics, it generates more recording and reproducing errors than magnetic disks formed on an aluminum substrate with NiP plating. It is believed that such errors result from the close contact property of the NiP layer being rather low. In other words, the close contact layer Cr in this device does not function well.

In general, the texture process is performed on magnetic disks through mechanical polishing of the surface of the NiP layer. When the texture process is performed, the direction of the easier magnetization of the magnetic layer can be directed more in the circumferential direction. As a result, a high signal to noise ratio (“S/N”) can be obtained to improve magnetic characteristics and to reduce contact of the head slider to the disk. In the magnetic disk disclosed in Japanese Published Unexamined Patent Application No. 10-145935, the close contact property of the NiP is rather low, which means that the NiP layer may be easily peeled due to polishing when conducting the texture process. Errors are generated in the peeled area. Moreover, because the NiP film can be peeled by external shock and contact with the head, reliability as the device ages is also lowered.

It is believed that high coercive force cannot be obtained from the magnetic disk disclosed in Japanese Published Unexamined Patent Application No. 10-145935. Tests revealed that surface roughness of the NiP layer after formation and the amount of polishing in the texture process influence the coercive force, and the above referenced magnetic disk received insufficient polishing of the NiP layer to obtain high coercive force.

The texture process is useful to raise the coercive force of the disk medium. The texture process involving about 2 nm of polishing was performed for the NiP plated layer of the magnetic disk illustrated in FIG. 1, and high coercive force was obtained. For the magnetic disk disclosed in Japanese Published Unexamined Patent Application No. HEI10-145935, the texture process for such an amount of polishing (2 nm or less) has been performed on the NiP layer formed by the sputtering process, but no increase in the coercive force was observed. The cause for this lack of increase may be due to an insufficient amount of polishing. A plated NiP layer has a rather rough surface and is effective for improving the coercive force by the texture process in the order of several nm, but the NiP layer formed by the sputtering process has a rougher surface and requires more polishing in order to attain higher coercive force. Accordingly, there is a need for disk media having sufficient hardness with good adhesion between layers, high coercive force and good recording characteristics.

### OBJECT OF THE INVENTION

Therefore, one object of the present invention is to provide a highly reliable disk medium.

Another object of the present invention is to provide a disk medium having improved shock resistance.

A further object of the present invention is to provide a disk medium assuring excellent close contact between a glass substrate and a NiP film.

Yet another object of the present invention is to provide a disk medium which is suitable for high recording density.

Still a further object of the present invention is to provide a disk medium which has high coercive force.

### SUMMARY OF THE INVENTION

The present invention is based on the discovery that the lower the substrate temperature is during formation of the NiP layer, the thicker the NiP layer may be formed. Conversely, the thinner the NiP layer is, the higher the substrate temperature may be during formation of the NiP layer. The disk medium of the present invention provides that the numerical sum of the substrate temperature T (° C.) and thickness t (nm) of NiP layer is 370 or less when the NiP layer is formed. According to this structure, the close contact property (adhesion) of the NiP layer is reinforced enough to be resistive to the texture process, and therefore, peeling of the NiP layer can be prevented almost completely.

The present invention is also based on the discovery that the thickness of the close contact layer provided between the substrate and NiP layer affects the close contact property of the NiP layer. The disk medium of the present invention has a Cr close contact layer with a thickness ranging from about 3 to 12 nm. The close contact property of the NiP layer can be improved by keeping the thickness of the close contact layer in this range.

Shock resistance can be improved by using a substrate that is glass, carbon or silicon as the non-magnetic substrate explained above. The close contact property between the glass substrate and NiP layer is also improved.

A desirable thickness of the NiP layer is in the range of about 40 to 200 nm. When the thickness of the NiP layer is 40 nm or more, conductivity of the substrate is acquired during formation of the film by the sputtering process, so breakdown of the substrate from charging can be prevented. Moreover, since the thickness of the NiP layer is set to 200 nm or less, a substrate temperature which assures a good close contact property of the NiP layer can be easily selected.

The magnetic disk of the present invention is completed by sequentially forming a non-magnetic close contact layer, a NiP layer, and a Cr-based underlayer on a non-magnetic substrate. The NiP layer is formed by the sputtering process, and the texture process is performed with the amount of polishing exceeding the maximum value of surface roughness after film formation, thereby significantly reducing the surface roughness. In the present invention, it has been found that surface roughness after formation of the NiP layer and the amount of polishing in the texture process influence the coercive force. This coercive force can be enhanced by setting the amount of polishing in the texture process larger than the maximum value of the surface roughness after formation of the NiP layer. For example, when the close contact layer is formed of Cr, surface roughness after formation of the NiP layer is about 5 nm and the amount of polishing by the texture process is set to 5 nm or more. According to this structure, the coercive force of the disk medium can be enhanced and fluctuation of coercive force within the surface can be suppressed. As a result, high density recording of disk medium can be assured.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a cross-sectional diagram illustrating an example of a magnetic disk of the related art;

FIG. 2 is a cross-sectional diagram illustrating another example of a magnetic disk of the related art;

FIG. 3 is a cross-sectional diagram of a magnetic disk of the present invention;

FIG. 4 is a plan view of a magnetic disk apparatus of the present invention;

FIG. 5 is a cross-sectional view along the line A-A of the magnetic disk apparatus illustrated in FIG. 4;

FIG. 6 is a cross-sectional diagram of a magnetic disk of the present invention;

FIG. 7 is a table illustrating the close contact property of the NiP layer for different thicknesses of the Cr contact layer;

FIG. 8 is a table illustrating the close contact properties of NiP layers having thicknesses made at different substrate temperatures;

FIG. 9 is a graph illustrating the relationship between the film thickness to acquire a good close contact property and the substrate temperature;

FIG. 10 is a graph illustrating the relationship between the amount of polishing performed in the texture process and the coercive force of the disk; and

FIG. 11 is a graph illustrating the relationship between the amount of polishing performed in the texture process and fluctuation in the coercive force of the disk.

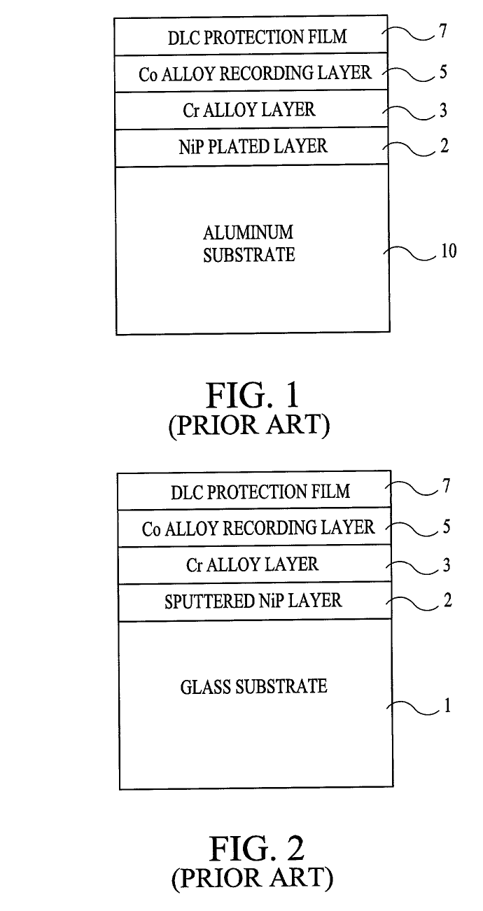

### DETAILED DESCRIPTION OF THE INVENTION

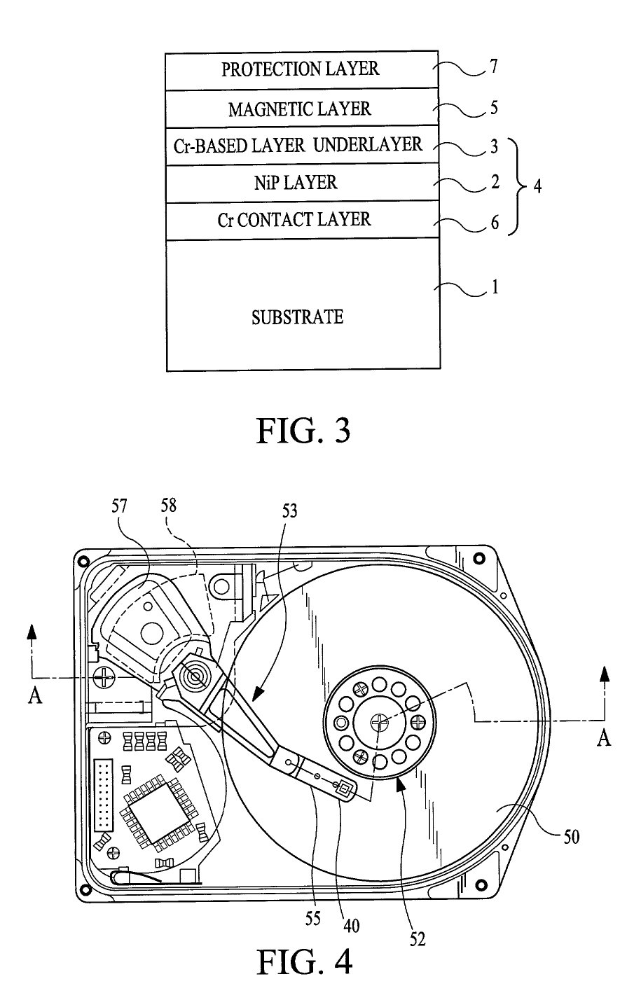

FIG. 3 is a cross-sectional diagram of a magnetic disk of the present invention. The magnetic disk is structured by providing a magnetic layer 5 consisting of a magnetic metal material on a non-magnetic substrate 1 via an underlayer 4. The underlayer 4 provided between the substrate 1 and magnetic layer 5 is composed of a close contact layer 6 including Cr next to the substrate 1, a NiP layer 2 formed on the close contact layer 6, and a Cr-based underlayer 3 formed on the NiP layer 2.

As will be explained below in detail, the magnetic layer 5 defines the circumferential direction as the direction of easy magnetization. The magnetic layer 5 may be formed by using a desired magnetic metal material (alloy) including Co as the main element. An alloy forming the magnetic layer 5 can add Cr and Pt to cobalt and combine Ta, Nb and B as required.

Moreover, as illustrated in FIG. 3, a protection layer 7 can be formed at the upper most layer, which is generally performed in the technical field of the present invention. The protection layer 7 is preferably formed of carbon or diamond like carbon (DLC).

In the magnetic disk of the present invention, a non-magnetic substrate used as the basic element may be formed of glass or similar non-magnetic material. For an adequate substrate material, glass, carbon or silicon may be used. However, it should be noted that other materials may also be used and are within the scope of the present invention. In the preferred embodiment of the present invention, since the glass substrate is preferred, the explanation which follows will be made on the basis of using a glass substrate.

The glass substrate may be selected from glass substrates generally used in the field, such as soda-lime glass, alumino-silicate glass, alkali-less glass, or crystallized glass. Of course, other glass substrates may be used and are within the scope of the present invention. These glass substrates may have a randomly uneven surface, as required.

Moreover, it is preferred that the surface of the glass substrates be cleaned before usage. Such cleaning of the glass substrate surface may be done by ordinary cleaning methods, such as a degreasing process using ultra-pure water, alkali cleaning agent and neutralized cleaning agent. A washing process using ion exchange water may also be combined. Lastly, a substrate surface activating process may be performed as required, in addition to using such cleaning processes.

The underlayer 4 is formed, as explained above, of at least one close contact layer 6 including Cr, NiP layer 2 and Cr-based underlayer 3. In the embodiment of the present invention, the close contact layer 6 is provided closest to the glass substrate.

The close contact layer 6 is formed between the substrate 1 and the NiP layer 2 in order to enhance the close contact property (i.e., adhesion) between the substrate 1 and NiP layer 2. The close contact layer 6 is preferably formed by the sputtering method such as the magnetron sputtering method. To enhance the close contact property, the close contact layer 6 is formed in the thickness of about 3 to 12 nm with the substrate temperature being in the range from room temperature to about 250 (° C.), and a sputtering condition such as Ar gas pressure of about 1 to 10 (mTorr).

Similar to the close contact layer 6, the NiP layer 2 is formed by the sputtering method such as the magnetron sputtering method. The NiP layer 2 is preferably formed in the thickness of about 40 to 250 nm under the substrate temperature range from room temperature to about 250 (° C.). In particular, an experimentally determinable relationship exists between the substrate temperature T and the thickness of the NiP layer 2 for enhancing the close contact property (adhesion) of the NiP layer 2. The lower the substrate temperature is, the thicker the NiP layer may be formed to obtain good adhesion. Conversely, the thinner the NiP layer is, the higher the substrate temperature may be set. As an example, the following lists are possible combinations: thickness of 40 to 250 nm for a substrate temperature of room temperature to 100° C., thickness of 40 to 200 nm for a temperature of 100 to 150° C., thickness of 40 to 150 nm for a temperature of 150 to 200° C., and 40 to 120 nm for a temperature of 200 to 250° C.

It is also preferred that the NiP layer 2 be subjected to a mechanical texture process along the circumferential direction. Namely, the NiP layer 2 is preferably used such that it has shallow projected line portions or grooves in the circumferential direction on the surface creating an uneven surface. The texture process at the surface of the underlayer can be performed mechanically in the magnetic disk manufacturing process depending on the technique used in general. As an adequate texture process, for example, the surface of the NiP layer 2 can be polished with polishing means such as a grind stone, polishing tape and isolated grain. Formation of an uneven surface by performing the mechanical texture process in the circumferential direction at the surface of NiP layer 2 can provide the effects of improved S/N ratio and improved traveling ability of the head for reading or writing data from or to the medium.

In the magnetic disk of the present invention, the Cr-based underlayer 3 mainly formed of Cr is provided on the NiP layer 2 as explained above. The Cr-based underlayer 3 may be formed of a metal material composed mainly of only Cr or a combination of Cr and Mo. Particularly, if Pt is included in the magnetic layer 5, the Cr-based underlayer 3 just under the magnetic layer 5 is preferably formed of a metal material composed mainly of Cr and Mo. Namely, the lattice surface interval may also be widened by adding Mo. Moreover, preferential alignment into the surface of the C axis of the magnetic layer (CoCr-based alloy) may be promoted, making the lattice surface interval of the underlayer of the magnetic recording film closer, which is enhanced depending on the composition of the magnetic recording film, particularly the amount of Pt. As an example of an adequate material of the Cr-based underlayer 3, Cr, CrW, CrV, CrTi, or CrMo, may be used. It is preferred that the Cr-based underlayer 3 be formed in the ordinary film forming condition by the use of the sputtering method such as the magnetron sputtering method. An adequate film forming condition may consist of a substrate temperature of 150 to 300 (° C.), Ar gas pressure of about 1 to 10 (mTorr) and DC negative bias of about 100 to 300(V). However, other film forming methods, such as an evaporation method and an ion beam sputtering method or the like, may be used as required in place of the sputtering method.

Here, the thickness of the Cr-based underlayer 3 may be changed to a wider range depending on various factors, but it is preferably set in the range of about 5 to 60 nm in order to raise the S/N ratio. When the thickness of the Cr-based underlayer is less than 5 nm, the magnetic characteristic probably becomes insufficient. On the contrary, noise tends to increase when it exceeds 60 nm.

In the magnetic disk of the present invention, the magnetic layer 5 is preferably formed, as is generally conducted in this field, of an alloy mainly composed of two layers of cobalt (i.e., Co—Ni based alloy and Co—Cr based alloy). In addition to such double-layer based alloy, the magnetic layer 5 may be formed of a three-element based alloy, four-element based alloy or five-element based alloy by freely adding platinum, niob, boron, tungsten and carbon, etc. It is preferable, from a characteristic point of view, to form the magnetic layer 5 with such multiple-element alloy.

It is also preferable that the magnetic layer 5 be formed using the Co—Cr based alloy with Cr in the concentration of 17 at % or more. If the NiP layer 2, which is essential in the present invention, does not exist on the glass substrate, enhancement in the concentration of Cr of the magnetic layer to realize low noise may be affected. This is because if the concentration of Cr of the magnetic layer 5 exceeds the peak value of 15 at % when there is no NiP layer, the direction of easy magnetization tends to be directed in the vertical direction, which lowers the S/N ratio. In other words, the NiP layer 2 is very effective, particularly in the magnetic layer having higher concentration of Cr. Again, the magnetic layer 5 may be formed as a single layer or as a double-layer or a multiple layer structure. In the case of the multiple layer structure, a non-magnetic film may be provided as the intermediate layer of the magnetic layers.

It is preferred that the magnetic layer 5 be formed using the sputtering method under the particular film forming condition. For example, the magnetron sputtering method may be used as in the case of formation of the underlayer. An adequate film forming condition may have a temperature of about 100 to 350 (° C.), but about 200 to 320 (° C.) is preferred, and particularly about 250 (° C.) or so, with an Ar gas pressure of about 1 to 10 (mTorr) and DC negative bias of about 80 to 400V. Moreover, if required, other film forming methods, such as the evaporation method and the ion beam sputtering method or the like may be used in place of the sputtering method. In the preferred example, the magnetic layer 5 is formed from the elements listed above at the film forming temperature of 150 to 350 (° C.) while DC negative bias is being applied.

Nevertheless, the preferred embodiment is to form the magnetic layer 5 and underlayer 4 by using the sputtering method. Namely, all films are formed by the sputtering method such that the thickness of the films is adjusted to the predetermined thickness or less, thereby maintaining the shock resistance property of the glass substrate.

Moreover, the magnetic disk of the present invention is capable of providing a protection layer 7 at the upper side of the magnetic layer 5 if required, but preferably as the upper most layer. An adequate material for the protection layer 7, a layer consisting of only carbon or its compound, may be a C layer, WC layer, SiC layer, B₄C layer, C layer with hydrogen, or diamond like carbon (DLC), which has recently attracted much attention for its higher hardness. However, it should noted that other materials may be used and are within the scope of the invention. Particularly, at this time, a protection layer consisting of carbon or DLC is preferred. Such a protection layer may be formed, for example, by the sputtering method and evaporation method. The thickness of such a protection layer 7 is preferably ranged from about 4 to 10 nm, although it may be changed to a wider range depending on various factors.

Such a protection layer may also be replaced with the amorphous hydrogenated carbon film (a-C: H film) disclosed in Japanese Published Unexamined Patent Application No. HEI 5-81660 or a similar protection layer. Japanese Published Unexamined Patent Application No. HEI 6-349054 discloses that the carbon protection layer with hydrogen using the sputtering method can be formed at least as a double-layer structure in which the lower carbon layer includes hydrogen with a low inclusion coefficient, and the upper carbon layer includes hydrogen with a higher inclusion coefficient for the purpose of improvement of durability and thickness in the contact-start-stop area of the disk (CSS), where the head is parked. Recently, the amorphous hydrogenated carbon film (PCVDa-C: H film) formed by the plasma CVD method is disclosed as the film to replace the sputtering a-C: H film. For example, Japanese Published Unexamined Patent Application No. HEI 7-73454 discloses a carbon protection layer manufacturing method using CF₄ as the reactive gas in the plasma CVD method. A fluorocarbon resin based lubricant layer may also be formed on the protection layer 7.

According to another aspect of the present invention, there is provided a disk apparatus using the disk of the present invention. The magnetic disk apparatus of the present invention is not limited to this structure, which basically provides the recording head for recording information and the reproducing head for reproducing information. In particular, the reproducing head is preferably a magneto-resistive head, namely a MR head that uses a magneto-resistive element changing its electrical resistance depending on the intensity of the magnetic field.

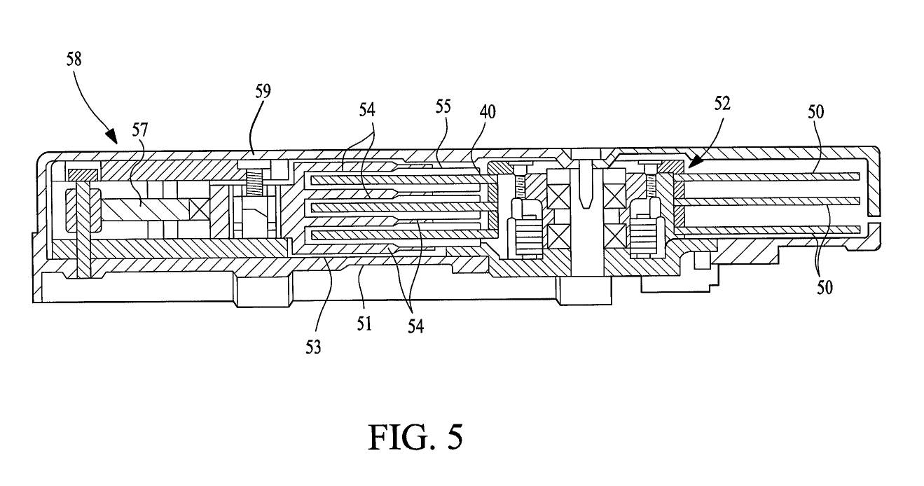

FIG. 4 illustrates a plan view of the magnetic disk apparatus with the cover removed, and FIG. 5 shows a cross-sectional view along the line A-A in FIG. 4. In these figures, a disk 50 has the structure illustrated in FIG. 3 and is driven to rotate by a spindle motor 52 provided on a base plate 51. Although three disks 50 are provided, it should be understood that a single disk or a plurality of disks may also be loaded and are within the scope of the invention.

An actuator 53 is provided to rotate on the base plate 51. At one rotating end of the actuator 53, a plurality of head arms 54 extended in the recording surface direction of the magnetic disk 50 are formed. At the rotating end portion of the head arm 54, a spring arm 55 is mounted. Moreover, a slider 40 is mounted to tilt, via an insulating film that is not illustrated, at the flexure portion of the spring arm 55. At the other rotating end of the actuator 53, a coil 57 is provided.

On the base plate 51, a magnetic circuit 58 formed of a magnet and a yoke is provided, and the coil 57 is arranged in the magnetic gap of this magnetic circuit 58. A moving coil type linear motor (VCM: voice coil motor) is composed of the magnetic circuit 58 and coil 57. The upper part of these base plates 51 is covered with a cover 59.

The operation of the magnetic disk apparatus of such structure will now be explained. When the magnetic disk 50 is in the stop condition, the slider 40 is in the stop condition through contact with the save (CSS or parking) zone of the magnetic disk 50. But when the magnetic disk 50 is driven to rotate at a higher speed by the spindle motor 52, the slider 50 floats from the disk surface while keeping a very small interval with the air flow generated by rotation of the magnetic disk 50. A current is applied to the coil 57 under this condition to generate a propulsive force, which is generated on the coil 57 for rotating the actuator 53. The head (slider 40) is then moved to the desired track on the magnetic disk 50 to read/write data.

In this magnetic disk apparatus, a conductive part near the magneto-resistive element is formed thinner while the other part is formed thicker, which is the conductive portion of the magnetic head. The curvature radius of the magnetic pole for the recording head can be made smaller so that the resistance of the conductive layer is lowered. As a result, information can be read accurately at a higher sensitivity when the offtrack is within a small range.

1. Samples Made By The Film Forming Process

Samples made by the film forming process of each layer will now be described.

A glass substrate was put into sputtering apparatus to form the Cr film and NiP as close contact layers on the glass substrate. The sputtering apparatus included a substrate heating chamber, a Cr film forming chamber and a NiP film forming chamber. The glass substrate was first heated by a heater in the substrate heating chamber. By adjusting the power supplied to the heater, the glass substrate temperature could be controlled.

The heated glass substrate was then transferred to the Cr film forming chamber to form the Cr layer (contact layer) with a preset Cr target. Here, the thickness of the contact layer was controlled by adjusting the power supplied to the Cr target. The glass substrate on which the contact layer was formed was then transferred to the NiP film forming chamber to form Ni₈₁P₁₉ or the like. The thickness of the NiP was similarly controlled by adjusting the power supplied to the NiP target.

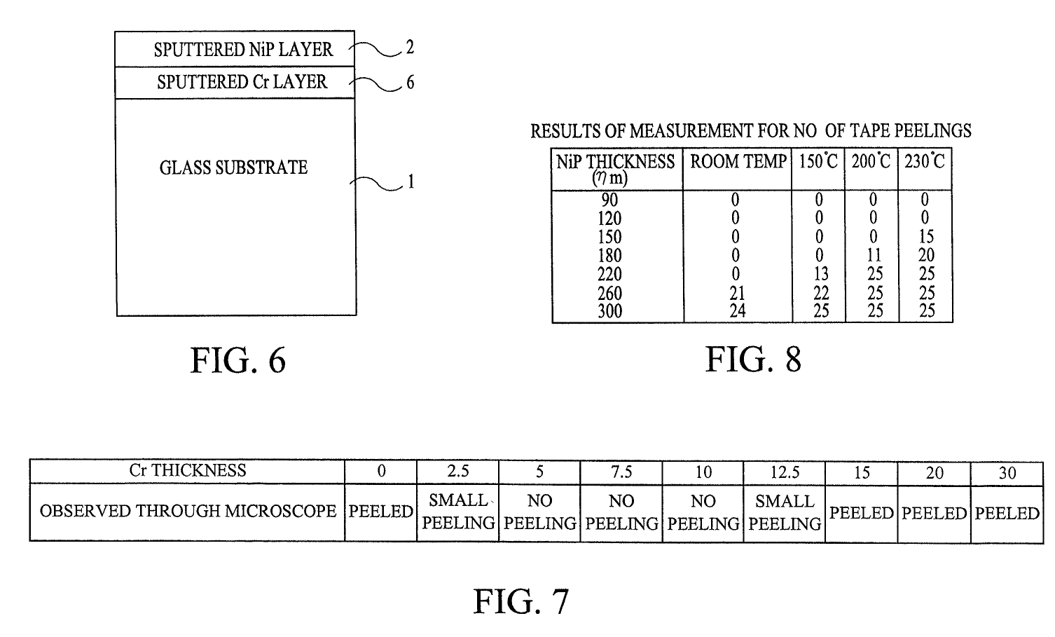

FIG. 6 illustrates the cross-section of disks manufactured using the above explained process. A plurality of samples having varying thicknesses of the contact layer 6 and the NiP layer 2 were manufactured by adjusting the power supplied to the Cr target and NiP target, respectively. Moreover, a plurality of samples having the contact layer 6 and NiP layer 2 were manufactured under various substrate temperatures. The maximum value Rₘₐₓ of the surface roughness of the NiP layer of these samples was 7 nm.

2. Evaluation Of Samples

The close contact property (adhesion) of the NiP film of the samples manufactured was evaluated by the following two methods.

Evaluation Method 1 (without polishing):

The close contact property of the NiP layers 2 of the samples was evaluated by the tape peeling method described in the Japanese Industry Standard JIS K 5400. With a cutter, the surface of the NiP layer 2 with a flaw including 25 square marks (5×5, each mark having a side of 2 mm size) was made. A cellophane adhesive tape was then attached on this flaw, and the cellophane tape was peeled after two minutes. Finally, the number of marks from which the NiP layer 2 was peeled was counted.

Evaluation Method 2 (with polishing):

The texture process was performed to the NiP layer 2, and the peeling of the film was observed with a microscope. Here, the amount of polishing of the NiP layer 2 was 15 nm using the texture process.

FIG. 7 illustrates the close contact property of the NiP layer 2 as a function of the thickness of the Cr in the contact layer 6. The thickness of the NiP layer 2 of the samples used for this evaluation was 90 nm and the substrate temperature for film forming of the NiP layer 2 was 150 (° C.).

To obtain the results shown in FIG. 7, the NiP layers 2 were peeled from the samples where the contact layers 6 were 15 nm or more using the tape peeling Evaluation Method 1 above. Furthermore, after the texture process based on Evaluation Method 2, the NiP film 2 was peeled in the samples where the contact layer 6 was 12.5 nm or more and 2.5 nm or less. From the data illustrated in FIG. 7, it can be seen that adequate thickness of the contact layer 6 ranges from about 3 to 12 nm for enhancing the close contact property of the NiP layer 2.

FIG. 8 illustrates the close contact property of the NiP layer 2 for various thicknesses of the NiP layer 2 and substrate temperatures when the NiP layer 2 was formed. Here, the close contact property of the NiP layer 2 was evaluated based on the Evaluation Method 1. The thickness of the contact layer 2 of the samples used for this evaluation was 8 nm.

From FIG. 8, it is understood that the thicker the NiP layer 2, the lower the substrate temperature is when peeling occurs. Conversely, the higher the substrate temperature, the thinner the thickness of the NiP layer 2 is when peeling occurs. On the basis of the results illustrated in FIG. 8, the thickness of the NiP layer 2 must be determined by the substrate temperature. Furthermore, adequate thickness of the NiP layer is 250 nm or less when the substrate temperature is ranged from room temperature to 100 (° C.). When the substrate temperature is ranged from 100 to 150 (° C.), adequate thickness of the NiP layer is 200 nm or less. For substrate temperatures ranging from 150 to 200 (° C.), adequate thickness of the NiP layer is 150 nm. Lastly, when the substrate temperature is ranged from 200 to 250 (° C.), adequate thickness of the NiP layer is 120 nm or less.

Because stable bias voltage is supplied to a substrate to form a magnetic layer on the NiP layer, the desirable thickness of the NiP layer should be 40 nm or more. Since the glass substrate is not conductive, it can easily accumulate charge with the bias voltage. When the glass substrate is charged, though, it can break down in the worst case. In order to prevent charging of the glass substrate, sufficient continuity with the holder for loading the substrate must be assured. For this purpose, the thickness of the NiP layer should be set at 40 nm or more. Moreover, if the thickness larger than the amount of polishing by the texture process is necessary, it is desirable that the NiP layer have a thickness of 40 nm or more. Also, the upper limit value of the thickness of the NiP layer must be under 260 nm, which generates peeling even when the substrate temperature is at room temperature. The desirable thickness of the NiP layer is about 200 nm.

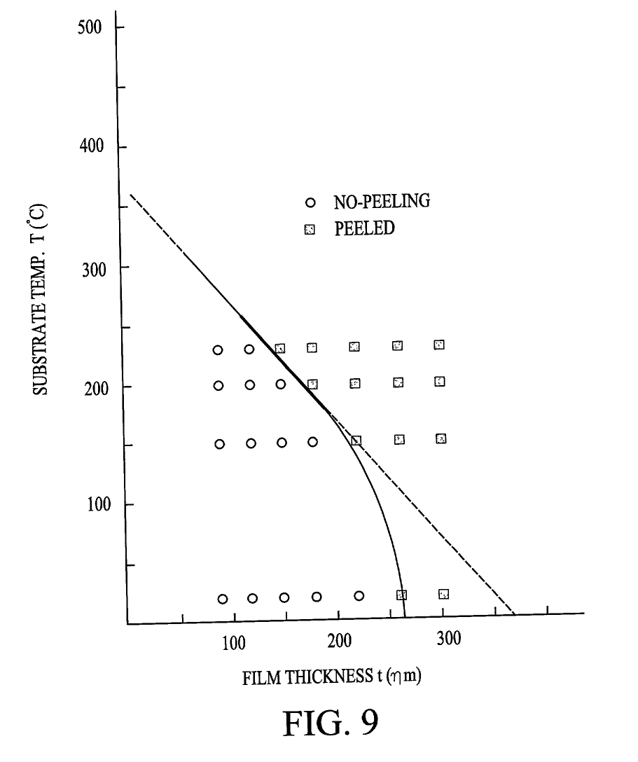

FIG. 9 illustrates the distribution of the close contact property generated based on the results from FIG. 8. The close contact property is plotted on a graph for each combination of the substrate temperature and thickness of the NiP layer.

In FIG. 9, the boundary between the high and low close contact property may be approximated to T=−t+370 under the condition that the thickness of the NiP layer is 40 to 200 nm, wherein the substrate temperature is defined as T (° C.) and the thickness of the NiP layer as t (nm). The area for obtaining higher close contact property is located at the lower area of the boundary, satisfying the condition of T =−t+370. Namely, the relationship of T+t=370 may be established.

3. Experimental Disk Polishing

After a contact layer 6 in the thickness of 8 nm and a NiP layer 2 in the thickness of 90 nm were formed on glass substrates 1 by using the sputtering method under the substrate temperature of 150 (° C.), the texture process was performed on the surface of the NiP layer 2 with variations in the amount of polishing. On the glass substrates 1 to which the texture process was performed, the Cr-based underlayer 3, Co-based magnetic layer 5 and protection layer 7 consisting of DLC were sequentially formed on the NiP layer 2. As a result, disk media having the cross-section illustrated in FIG. 5 were manufactured.

The amount of polishing in the texture process can be controlled by adjusting the polishing time. The polishing time is proportionate to the amount of polishing desired. The amount of polishing has been determined from the difference between thickness before the texture process and the thickness during the texture process by measuring, with an X-ray film measuring instrument, the thickness of the NiP layer 2 before the texture process and the thickness of the NiP layer 2 during the texture process.

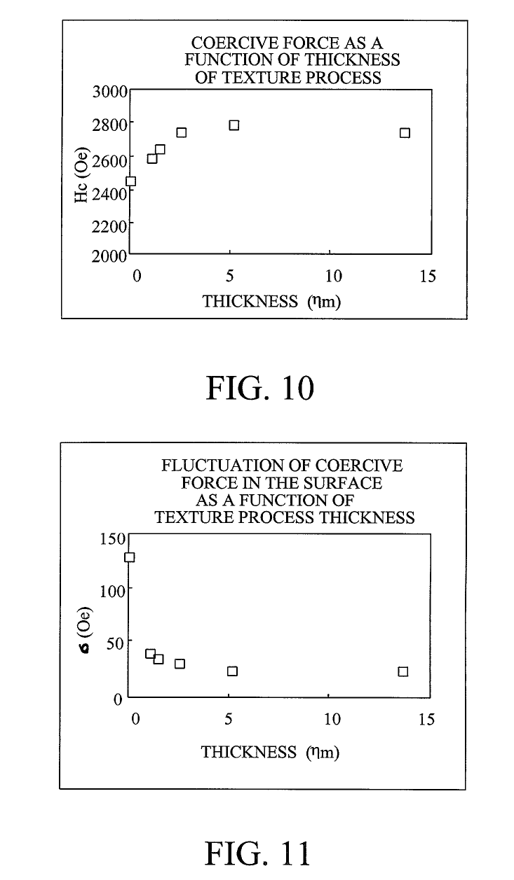

FIG. 10 is a graph illustrating the experimental relationship between the amount of polishing of the NiP layer by the texture process and the coercive force of a magnetic disk. It is apparent from FIG. 10 that a coercive force Hc increases with the increase in the amount of polishing and a value of Hc becomes identical in the samples that are polished for 5 nm or more.

FIG. 11 is a graph indicating the experimental relationship between the amount of polishing of the NiP layer by the texturing process and the fluctuation of coercive force. FIG. 11 suggests that fluctuation of Hc within the surface is reduced as the amount of polishing increases. Thus, the fluctuation of Hc can sufficiently be controlled to a small value by polishing for 5 nm or more. If the amount of polishing is excessive, the surface roughness of the disk surface becomes large because the circumferential line portions or grooves become deeper, in which case a head crash can easily result. Therefore, the desirable amount of polishing is 15 nm or less.

In the experimental samples, the maximum value Rₘₐₓ of the surface roughness of the NiP layer 2 before the texture process was 5 nm to 6 nm. From the results of FIG. 10 and FIG. 11, a more uniform and higher Hc can be obtained within the surface because the amount of polishing by the texture process is larger than the Rₘₐₓ of the NiP layer before the texture process.

The Cr contact layer of the present invention is applicable not only to a magnetic disk, but also to a medium from which data can be recorded or reproduced to or from the recording surface with a floating head. For example, this Cr contact layer may also be employed as the magnetic layer in a magneto-optical disk using material such as TbFeCo, DyFeCo, and to an optical recording medium using phase changing material.

As for the substrate, not only a glass substrate can be used but a plastic substrate may also be used. When the plastic substrate is used, the desirable substrate temperature for sputtering is 100 (° C.) or lower. Furthermore, it is desirable to employ magneto-optical recording material such as TbFeCo, DyFeCo or the like or phase changing material as the recording layer. TbFeCo and DyFeCo provide sufficient characteristics even when the film is formed with the substrate at room temperature. However, since an alloy of rare earth metal such as TbFeCo, DyFeCo and transition metal are used in vertical magnetization film, the texture process giving anisotropy in the direction of surface circumference is not required. As a result, the texture process will generate noise. Moreover, the texture process to the phase changing material will also generate noise.

A disk material of the present invention allows sequential formation of a contact layer including Cr, a NiP layer and a Cr-based underlayer on a non-magnetic substrate. Here, there is a relationship that a sum of the thickness t (nm) of the NiP layer and substrate temperature T during formation of the NiP layer is 370 or less to enhance the close contact property (adhesion) between the NiP layer and substrate. As a result, the texture process, which is effective for improvement in the S/N ratio of the medium, can be performed to the NiP layer to realize high density recording of the disk medium. In addition, shock resistance of the disk medium can be enhanced and reliability can also be improved.

In the above disk medium, the thickness of the contact layer is set within the range of 3 to 12 nm, thereby further improving the close contact property of the NiP layer. Moreover, in the disk medium of the present invention, a non-magnetic contact layer, a NiP layer and a Cr-based underlayer are sequentially formed on a non-magnetic substrate. Since a groove larger than the maximum value of the surface roughness of the NiP layer is formed in the circumferencial direction on the surface of the NiP layer, more uniform and higher coercive force can be obtained within the surface. As a result, high recording density of the disk media can be attained.

While the principles of the invention have been described above in connection with the specific apparatus and applications, it should be understood that this description is made only by way of an example and not as a limitation on the scope of the invention.

What is claimed is:

1. A disk medium comprising:
a contact layer including Cr formed on a non-magnetic substrate;
a NiP layer formed on said contact layer;
a Cr-based underlayer formed on said NiP layer; and
a magnetic layer formed on said Cr-based underlayer,
wherein said NiP layer is formed by a sputtering process under the condition of a substrate temperature of T(° C.) and thickness of t (nm) such that the value of t+T is equal to or less than 370.

2. The disk medium of claim 1 wherein said thickness t (nm) is ranged from 40 to 200 (nm).

3. The disk medium of claim 1 wherein said non-magnetic substrate includes any one of glass, carbon and silicon.

4. The disk medium of claim 1 wherein said contact layer has a thickness ranged from 3 to 12 nm.

5. A disk medium comprising:
a contact layer including Cr formed on a non-magnetic substrate;
an NiP layer formed on said contact layer;
a Cr-based underlayer formed on said NiP layer; and
a magnetic layer formed on said Cr-based underlayer,
wherein said NiP layer is formed by the sputtering method and a plurality of grooves having a depth larger than the maximum value of surface roughness of said NiP layer after the film formation are formed along the circumferential direction.

6. The disk medium of claim 5 wherein said contact layer is mainly formed of Cr.

7. The disk medium of claim 5 wherein a depth of said grooves is ranged from about 5 to 15 nm.

8. The disk medium of claim 5 wherein said contact layer has a thickness ranged from about 3 to 12 nm.

9. A disk apparatus comprising:
a disk medium;
a head recording data to and reproducing data from said disk medium; and
a spindle motor rotating said disk medium,
wherein said disk medium comprises a contact layer including Cr formed on a non-magnetic substrate, NiP layer formed on said contact layer, Cr-based underlayer formed on said NiP layer, and magnetic layer formed on said Cr-based underlayer, wherein said NiP layer is formed by the sputtering process under the condition of a substrate temperature of T (° C.) and a thickness of t (nm) such that the value of t+T is equal to or less than 370.

10. A disk apparatus comprising:
a disk medium;
a head recording data to and reproducing data from said disk medium; and
a spindle motor rotating said disk medium,
wherein said disk medium comprises a contact layer including Cr formed on a non-magnetic substrate, NiP layer formed on said contact layer, Cr-based underlayer formed on said NiP layer, and a magnetic layer formed on said Cr-based underlayer, wherein said NiP layer is formed by the sputtering method and a plurality of grooves having a depth larger than the maximum value of the surface roughness of said NiP layer after the film formation are formed along the circumferential direction.
